(19) United States
(12) Patent Application Publication
(10) Pub. No.: US 2006/0095935 A1
(43) Pub. Date: May 4, 2006

(54) Method for receiving digital broadcast signal

(75) Inventors: Shinichi Ooi, Tokyo (JP); Osamu Yoshida, Kawasaki-shi (JP); Masakazu Koike, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/260,266

(22) Filed: Oct. 28, 2005

(30) Foreign Application Priority Data
Oct. 29, 2004 (JP) P.2004-316694

(51) Int. Cl. H04N 7/16; H04N 7/167

(52) U.S. Cl. 725/25; 725/31

(57) ABSTRACT

In a digital broadcast receiver, an ECM and an EMM are separated from a digital signal of a selected channel. The separated ECM and EMM are decoded. The digital signal is scrambled using a scramble key obtained from the decoded ECM. Whether or not viewing the desired program is permitted is determined using the decoded ECM and the decoded EMM. Whether or not receiver is revoked is determined from the decoded EMM. When it is determined that the receiver is revoked, the receiver is connected to a revoke relevant information providing server for providing revoke relevant information and the revoke relevant information is acquired and the acquired revoke relevant information is output.

### RELATED APPLICATIONS

The present disclosure relates to the subject matter contained in Japanese Patent Application No. 2004-316694 filed on Oct. 29, 2004, which is incorporated herein by reference in its entirety.

### BACKGROUND

1. Field of the Invention

The present invention relates to a digital broadcast reception method.

2. Description of the Related Art

In broadcasts using a communication satellite and a broadcast satellite, a digital broadcast service has been conducted and also in terrestrial broadcasts, a digital broadcast service has begun.

Generally, in broadcasts using a communication satellite and a broadcast satellite, the user makes a contract to a provider that provides broadcasting services and views the broadcasting on a chargeable basis in various units such as channel units, program units, or time units. Thus, a limited reception system is conducted wherein content to be broadcast is scrambled and is descrambled only in viewable units based on the view contract, such as only the program, only the time period, or only the channel, for example, for enabling the user to view. According to the limited reception system, individual information (EMM: Entitlement Management Message) responsive to the contract state, etc., of the user is transmitted individually to each receiver installed at home and the individual information (EMM) is set individually for each receiver.

On the other hand, in terrestrial broadcasts, a mode of generally viewing on a free-of-charge basis from analog broadcasts is adopted and at present, service of only free broadcasts is also conducted in terrestrial digital broadcasts. In Japan, from April 2004, even broadcasts viewable on a free-of-charge basis are also scrambled and broadcast like pay broadcasts using a broadcast satellite to secure a copyright on broadcast content, which will be hereinafter referred to as broadcast with content protected by copyright. In the broadcast with content protected by copyright, it is also predicted that content with a limit of copy at once for allowing only one copy to be made will become mainstream to enhance copyright protection.

At present, a copyright protection system called RMP system (Rights Management and Protection system) is examined for a receiver for receiving terrestrial digital broadcasts. In the RMP system, a technique to enhance copyright protection, called “revoke” to inhibit an illegal receiver from receiving broadcast if the function of copyright protection is violated is known. (For example, refer to JP-A-2001-078154)

### SUMMARY

There is a possibility that revoke will be executed in broadcast with content protected by copyright. If revoke is executed, it is predicted that a bona fide viewer who becomes unable to view although he or she does not violate the function of copyright protection will occur. The bona fide viewer is a viewer who uses a receiver not violating the function of copyright protection and is involved in revoke if revoke is executed as a result of using a receiver of a specific model for action violating the function of copyright protection by some malicious persons.

In a case where the revoke is executed in a digital broadcast receiver in the related art, it becomes impossible to normally receive broadcast and therefore the bona fide viewer cannot obtain appropriate information.

The present invention provides appropriate information for a bona-fide viewer and also provide a viewable state as much as possible if revoke is executed.

A method according to one aspect of the present invention is a method for receiving a digital broadcast signal by a digital broadcast receiver. The method includes: selecting a channel of any desired program out of the digital broadcast signal in which an ECM (Entitlement Control Message) and an EMM (Entitlement Management Message) are multiplexed and revoke information indicating whether or not the digital broadcast receiver is revoked is inserted into the EMM; separating the ECM and the EMM from the digital broadcast signal of the selected channel; decoding the separated ECM; decoding the separated EMM; descrambling the digital broadcast signal using a scramble key obtained from the decoded ECM; determining whether or not viewing the desired program is permitted using the decoded ECM and the decoded EMM; determining whether or not the digital broadcast receiver is revoked based on the decoded EMM; connecting to a server that provides revoke relevant information and acquires the revoke relevant information when determined that the digital broadcast receiver is revoked; and outputting the acquired revoke relevant information.

### BRIEF DESCRIPTION OF THE DRAWINGS

In the accompanying drawings:

FIG. 1 is a block diagram to describe the configuration of a digital broadcast receiver according to a first embodiment;

FIG. 2 is a flowchart to describe the operation of the digital broadcast receiver according to the first embodiment;

FIG. 3 is a flowchart to describe the operation of a digital broadcast receiver according to a second embodiment; and

FIG. 4 is a block diagram to show the configuration of a digital broadcast receiver according to a third embodiment.

### DETAILED DESCRIPTION OF THE EMBODIMENTS

Referring now to the accompanying drawings, there are shown preferred embodiments of the invention. The invention is not limited to the specific embodiments and can be used as various designs.

### First Embodiment

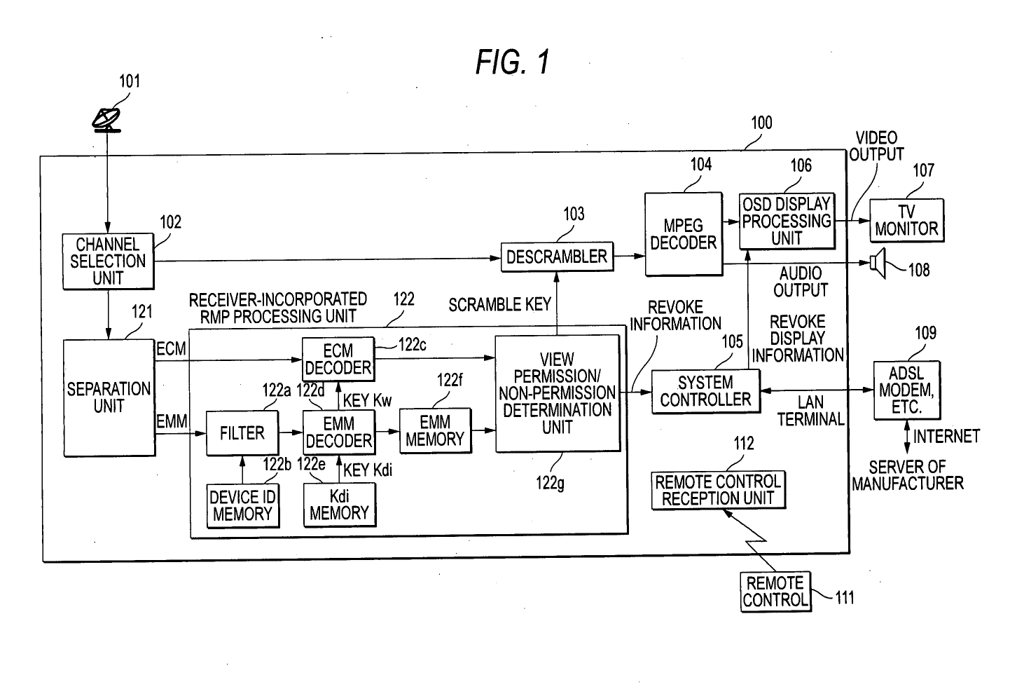

FIG. 1 is a block diagram to show the configuration of a digital broadcast receiver according to a first embodiment.

In FIG. 1, a description is given centering on the functional blocks relating to the present proposition and a processing unit of programming information (service information (SI), program specific information (PSI)), a processing unit for providing electronic program guide information using the programming information for the viewer, and the like essentially required as a receiver are not shown. Processing of demultiplexing an MPEG2 transport stream, processing of decoding video and audio from the demultiplexed signal, a processing sequence for outputting video and audio signals from the MPEG2 transport stream, and the like are collected in description of MPEG decoder.

As shown in FIG. 1, a digital broadcast receiver 100 includes a channel selection unit 102 for selecting the channel of any desired program from broadcast waves sent from an antenna 101 for receiving broadcast signals, a descrambler (descramble unit) 103, an MPEG decoder 104 to which a descrambled signal from the descrambler 103 is input, a system controller 105 for controlling the whole system of the digital broadcast receiver 100, an OSD (on-screen display) display processing unit 106 to which a signal from the MPEG decoder 104 is input, a remote control reception unit 112, a separation unit 121 for separating an ECM (Entitlement Control Message) and an EMM (Entitlement Management Message) from the signal supplied from the channel selection unit 102, and a receiver-incorporated RMP processing unit 122.

The ECM is a data message in common to each of the digital broadcast receiver 100 and includes: information related to the program; a descramble key for descrambling the digital broadcast signal; and control information for forcibly validating or invalidating the descramble process.

The EMM is a data message specific for each of the digital broadcast receiver 100 and includes: subscriber information specific to each of the subscriber (user (viewer) of each of the digital broadcast receiver 100); and key information (work key) for decrypting the ECM.

The RMP processing section 122 includes a filter 122a, device ID memory 122b for storing the device ID, an ECM decoder 122c, an EMM decoder 122d, device-key memory 122e for storing a key Kdi, EMM memory 122f, and a view permission/non-permission determination unit 122g for determining whether or not view is permitted from the ECM and EMM.

Provided outside the digital broadcast receiver 100 are a monitor 107 and a speaker 108 for playing back video and audio signals, an ADSL (Asymmetric Digital Subscriber Line) modem 109 for connecting to a server, and a remote control 111 for remotely operating the digital broadcast receiver 100.

When the view permission/non-permission determination unit 122g in the RMP processing section 122 determines that view is permitted from the ECM and EMM, it outputs a descramble key to the descrambler 103. Consequently, the digital broadcast receiver 100 plays the correctly descrambled program, thus enabling the user to view the program.

When the view permission/non-permission determination unit 122g in the RMP processing section 122 determines that the state is a revoke state from the ECM and EMM, it does not output a descramble key to the descrambler 103 for inhibiting the user from viewing the program. In addition, the view permission/non-permission determination unit 122g gives revoke information indicating the revoke state to the system controller 105 for controlling the system.

The digital broadcast receiver 100 is compatible with “copyright protection system” (RMP system: Rights Management and Protection system) whose standardization is examined by facilities such as ARIB (incorporated body, Denpa Sangyoukai: Association of Radio Industries and Buisnesses). In the “copyright protection system,” scramble is used in free broadcasts and only receivers capable of protecting the program copyright can demodulate the programs correctly.

According to the above configuration, it is made possible to prevent an unauthorized copy of a broadcast program. Specifically, program copyright protection in digital broadcast receivers is accomplished as described in the follows.

The broadcasting party transmits the program use condition of the number of times the program can be copied and the like (right protection information) by broadcast waves together with the program.

The broadcasting party manages a key for scrambling the program, etc., (scramble key in FIG. 1) and a key for performing encryption processing to transmit the scramble key with safety (work key Kw in FIG. 1).

Further, the broadcasting party also manages a key to encrypt the work key Kw for transmission (device key Kdi in FIG. 1) so as to give the work key Kw only to the receiver operating in accordance with the use condition indicated in the right protection information, and distributes the device key Kdi only to the receiver operating in accordance with the use condition indicated in the right protection information.

It is made possible for the receiver manufacturer promising to manufacture the receiver operating in accordance with the use condition indicated in the right protection information to incorporate the distributed device key Kdi in the receiver before shipment at the manufacturing time, etc., of the receiver.

Thus, the receiver operating in accordance with the use condition indicated in the right protection information obtains the work key Kw and the scramble key from the given device key Kdi and descrambles the program although described later in detail.

To output the descrambled program to an external connection machine, the descrambled program is output only if the external connection machine also operates in accordance with the use condition indicated in the right protection information. At this time, the program is output with the right protection information added.

The program provider right is thus protected.

Next, the operation of the digital broadcast receiver 100 shown in FIG. 1 is as follows.

The digital broadcast receiver 100 is connected to the antenna 101. The antenna 101 is an antenna for receiving broadcast waves. Here, a parabola antenna for satellite broadcasts is shown; for terrestrial digital broadcasts, a Yagi-type antenna, etc., often used for UHF band is used. The broadcast waves received at the antenna 101 are input to the channel selection unit 102 of the digital broadcast receiver 100.

The channel selection unit 102 selects the signal of the channel specified by the viewer, performs demodulation processing, synchronization detection, error correction processing, etc., and outputs an MPEG2 transport stream to the descrambler 103 and the separation unit 121. For the viewer to specify a channel, the signal originated from the remote control 111 shown in FIG. 1 is received at the remote control reception unit 112 and is analyzed by the system controller 105 and then is sent to the channel selection unit 102 through a signal line (not shown). It is a common practice to use a microcomputer as the system controller 105.

The descrambler 103 descrambles the video and audio signals and the data broadcast signal of the program selected by the viewer so as to make it possible to view and use the program and the signal, and outputs the descrambled signals to the MPEG decoder 104. The scramble key given to the descrambler 103 is input from the view permission/non-permission determination unit 122g.

The MPEG decoder 104 decodes the signal descrambled by the descrambler 103 and outputs the post-decoded video signal to the external monitor 107 via the OSD display processing unit 106 and outputs the audio signal to the external speaker 108. The monitor 107 plays the video signal and the speaker 108 plays the audio signal.

The OSD display processing unit 106 generates an OSD display screen based on the signal from the system controller 105, combines the generated OSD display screen and a screen based on the signal output by the MPEG decoder 104, and outputs the resultant signal to the monitor 107.

The receiver for making it possible to protect the copyright protects the post-descrambled signal in accordance with the right protection information transmitted with the programming information (SI, PSI) of the broadcast signal and outputs the post-descrambled signal from an output interface (not shown). The right protection information refers to copy control information indicating that the program can be copied only once, can be copied any number of times, or is copy-inhibited, information specifying encryption processing for the signal at the output time, etc.; specifically it means a digital copy control descriptor and a content use descriptor. The right protection information can increase with the future standardization.

The programming information (SI, PSI) containing the right protection information is separated from the output signal from the channel selection unit 102 by a processing section (not shown) to take out the right protection information. This topic does not directly relate to the invention and therefore will not be discussed in detail.

The separation unit 121 separates ECM and EMM from the signal input from the channel selection unit 102 and outputs the ECM and EMM to the receiver-incorporated RMP processing unit 122.

Next, processing of the RMP processing section 122 will be discussed. In the processing of the RMP processing section 122, at least the ECM decoder 122c, the EMM decoder 122d, the device-key memory 122e, the EMM memory 122f, and the view permission/non-permission determination unit 122g are functional blocks where software processing is considered to be often performed by a microcomputer, etc.

The EMM is input to the filter 122a.

The filter 122a further separates only the EMM for the digital broadcast receiver 100 having the device ID for the receiver and outputs the EMM to the EMM decoder 122d. To separate the EMM, the device ID given to the digital broadcast receiver 100 having the device ID is used. The device ID is a unique ID for each receiver model or manufacturer and is stored in the device ID memory 122b in the RMP processing section 122 before product shipment. The device ID memory 122b is nonvolatile memory. Only the EMM for the digital broadcast receiver 100 is thus separated.

The ECM is input to the ECM decoder 122c.

The ECM decoder 122c decrypts the ECM and outputs the decrypted ECM to the view permission/non-permission determination unit 122g. The key used for the decryption processing is the key Kw transmitted as a part of information of the EMM described later.

The ECM is information containing the scramble key used to encrypt broadcast content (which includes data such as video data and audio data) and information indicating view conditions. The information indicating view conditions is information indicating program view conditions, namely, information indicating whether the broadcast is a chargeable (pay) or free broadcast and information to determine whether or not the broadcast can be viewed in comparison with the EMM (individual information) described later.

The EMM decoder 122d decrypts the EMM input from the filter 122a and outputs the decrypted EMM to the ECM decoder 122c and the EMM memory 122f. The key used for decryption processing is the key stored in the device-key memory 122e before product shipment and is unique for each receiver model or manufacturer.

The EMM memory 122f is nonvolatile memory for storing the EMM decrypted by the EMM decoder 122d. The EMM memory 122f outputs the stored EMM to the view permission/non-permission determination unit 122g. The EMM memory 122f may also store the above-described key Kw (work key) and may give the key Kw to the ECM decoder 122c. FIG. 1 assumes that the EMM decoder 122d contains nonvolatile memory of the key Kw to easily see the triple structure of the keys.

The EMM is information containing at least the key Kw to decode the EMM, the device ID, and information (revoke information) indicating whether or not the receiver having the key Kw is revoked.

The work key Kw may be updated at regular time intervals, for example, once a month for the purpose of preventing degradation of security; at the updating time, EMM in which a new update work key is entered is previously sent to all receivers of the device ID. In the broadcast station, the work key is updated as soon as almost all receivers can receive the EMM in which the new work key is entered.

The described revoke is action executed by the broadcaster if the receiver of the device ID is authorized as a receiver capable of protecting the program right in the begging and is manufactured with the device key Kdi provided therefor, but later the function of program right protection is changed for the worse, etc., by a malicious user for making ineffective the function of program right protection (namely, modification is made so that content that can be copied only once is output as content that can be copied any number of times or the like); the user of the receiver of the device ID is inhibited from viewing the program. In this case, a new work key is sent only to authorized receivers other than the receiver having the revoked device ID and device key Kdi for update. Accordingly, it is made impossible for the revoked receiver to obtain the new work key Kw.

As a result, the revoked receiver cannot correctly decode by the ECM decoder 122c after the work key Kw is updated, and the user of the receiver cannot view the program.

Excluding the illegal (changed for the worse) receiver with the function of program right protection made ineffective, etc., from the broadcast system is here called revoke.

Whether or not the receiver to which the work key Kw is not sent is removed is not clearly known as the work key Kw is not sent with the EMM. Thus, information indicating that the receiver is revoked (which will be hereinafter referred to as revoke information) is sent with the EMM to make the revoked receiver recognize the revoke.

As described above, when the receiver is not revoked, correct decoding is performed by the ECM decoding section and the correct scramble key can be output unless trouble of power off of the receiver at the updating time of the work key occurs.

The described revoke information is output to the system controller 105. Since the transmission capacity of the EMM is limited, information is not transmitted with the revoke information beyond the information indicating whether or not the receiver is revoked.

Therefore, in the embodiment, the following configuration is provided to provide appropriate information for bona-fide viewers when revoke is executed.

In the embodiment, it is assumed that the digital broadcast receiver 100 is provided with a LAN terminal so as to be able to connect to an information providing server of the receiver manufacturer, as shown in FIG. 1.

The LAN terminal is connected to the system controller 105 and is connected to a machine to connect to a computer network such as the Internet, such as the ADSL modem 109, as an external block of the digital broadcast receiver 100.

In FIG. 1, the ADSL modem is adopted as the system for connecting to the Internet by way of example. However, a DSL modem may be adopted or any other connection method such as Internet connection using an optical fiber network may be adopted. The modem may be incorporated in the digital broadcast receiver 100.

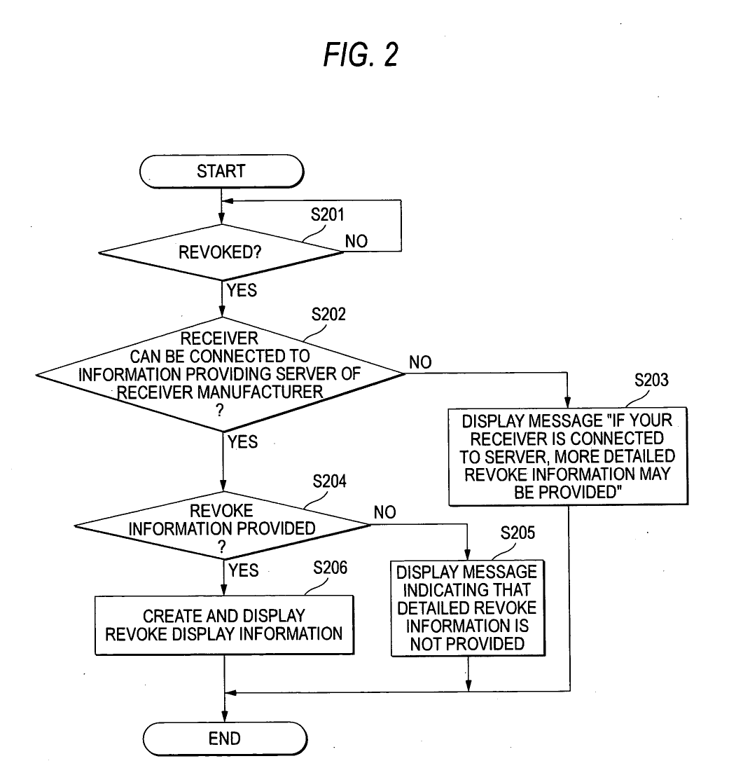

Next, the operation of the system controller 105 at the time will be discussed with a flowchart of FIG. 2.

First, as step S201, whether or not revoke information is given from the view permission/non-permission determination unit 122g is determined.

If it is determined at step S201 that revoke information is given and the receiver is revoked, the process proceeds to step S202.

On the other hand, if it is determined at step S201 that revoke information is not given and the receiver is not revoked, step S201 is repeated as loop processing. Thus, if revoke information is not given, the user of the receiver can view programs. If the user of the receiver cannot view programs although revoke information is not given, it is assumed that the receiver cannot yet receive the EMM containing the work key Kw and the user of the receiver cannot view programs although the work key Kw is updated for broadcasting as a broadcast signal for the reason such that the power is off for a long time, for example. In such a case, if the receiver is operated in the time period of transmission of the EMM, the EMM can be acquired and it is made possible to receive the program correctly.

Next, at step S202, whether or not the receiver can be connected to the information providing server of the receiver manufacturer on the Internet is determined. In the example in FIG. 1, whether or not the LAN terminal of the receiver can be connected through the ADSL modem 109 to the information providing server of the receiver manufacturer on the Internet is determined.

When determined at step S202 that the receiver can be connected to the information providing server of the receiver manufacturer on the Internet, the process proceeds to step S204. In the embodiment, information is provided by OSD display by way of example, but the invention is not limited to this configuration and the information may be provided by any other means such as voice.

On the other hand, when determined at step S202 that the receiver cannot be connected to the information providing server of the receiver manufacturer on the Internet, the process proceeds to step S203. It is assumed that information for connecting to the information providing server of the receiver manufacturer, for example, information of the URL, the IP address, etc., of the information providing server is previously stored in memory in the receiver and the system controller 105 connects the receiver to the information providing server in accordance with the stored information.

In the description of the embodiment to follow, information is provided for the user by OSD display by way of example, but the invention is not limited to it; information may be provided by any other means such as voice.

At step S203, information indicating that “if your receiver is connected to the information providing server of the receiver manufacturer on the Internet, more detailed revoke information may be provided” is displayed for the viewer and then the processing is terminated. To display the information at step S203, the system controller 105 outputs information required for display (information indicating that “if your receiver can be connected to the information providing server of the receiver manufacturer on the Internet, more detailed revoke information may be provided”) to the OSD display processing unit 106, which then superposes the information on the signal of the TV screen or switches to the information for display.

The display is provided for informing the viewer that “if your receiver can be connected to the information providing server of the receiver manufacturer on the Internet, more detailed revoke information may be provided”); it is display for prompting the viewer to make Internet connection, namely, prompting the viewer to check whether or not receiver setting, modem connection, etc., is made for Internet connection.

At step S204, whether or not revoke information is provided by the information providing server is determined. If it is determined at step S204 that revoke information is provided, the process proceeds to step S206. On the other hand, if it is determined at step S204 that revoke information is not provided, the process proceeds to step S205.

At step S205, for example, a message for informing the viewer that detailed information is not provided at the moment is displayed and then the processing is terminated. To display the message, the system controller 105 also outputs display information to the OSD display processing unit 106 for displaying the message.

At step S206, revoke information is acquired from the information providing server and the system controller 105 outputs display information to the OSD display processing unit 106 and then the processing is terminated.

The revoke information is, for example, information provided from an information providing server and displayed as OSD on an external monitor and is, for example, the following information:

(1) Information identifying the current revoked model. For example, information of the manufacturing number, the model number, the manufacturing years, months, etc.

(2) Information concerning steps taken by the receiver manufacturer for revoke. For example, software update of the receiver, machine replacement, replacement of parts in the receiver, and replacement schedule.

(3) Information concerning contact information about revoke. For example, the telephone number and the mail address.

As described above, according to the embodiment, when revoke is executed, appropriate information can be provided for bona-fide viewers. The bona-fide viewer can know how the receiver manufacturer takes steps from the state in which the receiver is revoked and the reviewer cannot view programs. It is made possible for the bona-fide viewer to obtain information indicating the steps to be taken.

As described above, in the embodiment, the system controller 105 serves as a revoke determination unit that determines whether or not the digital broadcast receiver is revoked based on the EMM decoded by the EMM decoder.

In the embodiment, the system controller 105 serves as a revoke relevant information acquisition unit that connects to a server that provides revoke relevant information and acquires the revoke relevant information when the revoke determination unit determines that the digital broadcast receiver is revoked.

In the embodiment, the system controller 105 serves as an output unit that outputs the revoke relevant information acquired by the revoke relevant information acquisition unit.

In the embodiment, the system controller 105 serves as a connection unit that connects to a server that provides software update data and acquires the software update data when the revoke determination unit determines that the digital broadcast receiver is revoked.

In the embodiment, the system controller 105 serves as an update unit that updates software installed in the digital broadcast receiver using the software update data acquired by the connection unit.

In the embodiment, the system controller 105 serves as a reception system switching unit that switches a reception system of the digital broadcast receiver between a broadcast system for stationary receivers and a broadcast system for mobile receivers.

In the embodiment, the system controller 105 serves as a controller that, when the revoke determination unit determines that the digital broadcast receiver is revoked in one of the broadcast systems for stationary receivers and for mobile receivers, controls the reception system switching unit to switch to the other of the reception systems.

Only the function of displaying has been described in the above description of the embodiment, but the function of erasing the display as intended by the viewer is available in processing of any steps.

### Second Embodiment

A second embodiment of the invention will be discussed. The second embodiment is a modification of the first embodiment and only the differences from the first embodiment will be discussed.

In the first embodiment described above, processing is until display of revoke information.

In the second embodiment, when a digital broadcast receiver is illegally changed for the worse as the function of program right protection is made ineffective as the revoke cause (when the digital broadcast receiver is revoked), the software of the digital broadcast receiver is updated for recovering the digital broadcast receiver from the revoke state.

In this case, to update the software of the digital broadcast receiver, it is necessary to accomplish (1) and (2) as follows:

(1) A function of making ineffective the function of program right protection cannot again be incorporated in the receiver or is hard to be incorporated in the receiver.

(2) The device ID and the device key Kdi can be updated to new device ID and device key Kdi. The new device key Kdi cannot be or is hard to be read for use with the digital broadcast receiver illegally changed for the worse.

If (1) and (2) can be accomplished, the software of the digital broadcast receiver is worth updating. That is, it is necessary to prevent the function of program right protection from being again made ineffective in the receiver after the software is updated.

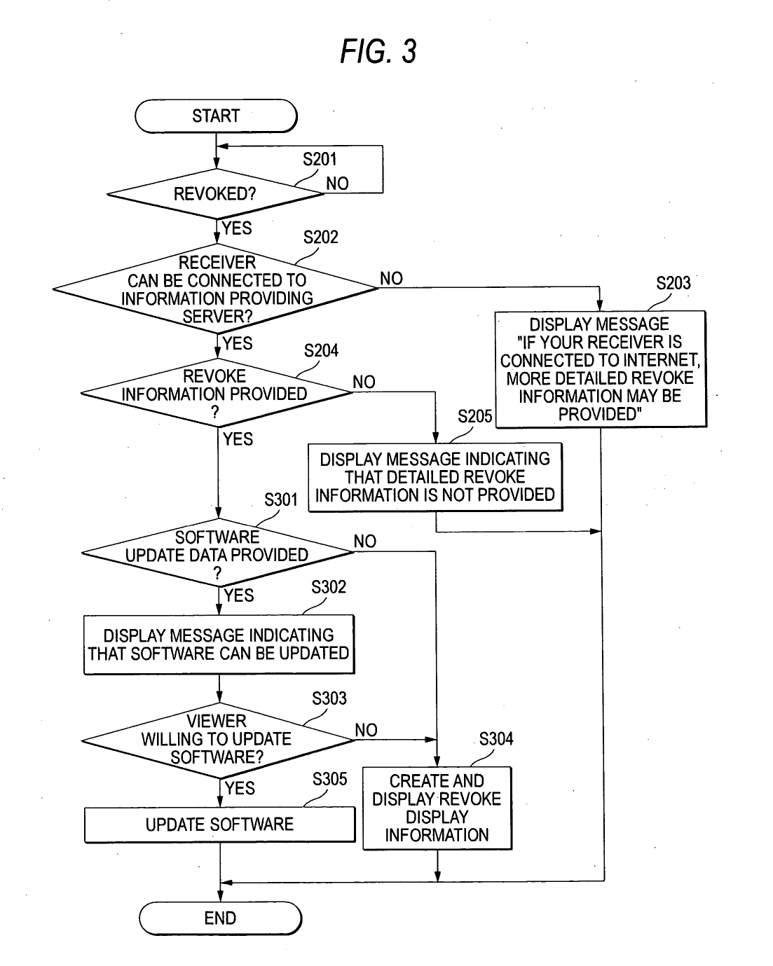

In this case, the operation of a system controller 105 will be discussed with a flowchart of FIG. 3.

The flowchart of FIG. 3 differs from the flowchart of FIG. 2 in processing of step S301 and the later steps. The operation at step S301 and the later steps will be discussed in detail below:

At step S301, whether or not data concerning software update is provided in an information providing server is determined. If data is provided at step S301, the process proceeds to step S302; if data is not provided, the process proceeds to step S304.

At step S302, the system controller 105 uses the information obtained from the information providing server to output display information concerning revoke and software update to an OSD display processing unit 106 for displaying the information. In this case, the information provided from the information providing server and displayed is, for example, the following:

(1) Information identifying the current revoked model. For example, information of the manufacturing number, the model number, the manufacturing years, months, etc.

(2) To update the software of the receiver as the step to be taken by the receiver manufacturer for the revoke.

(3) If the software is updated, the receiver is recovered from the revoke state, enabling the user to again view programs.

(4) Requesting the viewer to determine whether or not to want to update the software of the receiver.

At step S303, the system controller 105 waits for the viewer to respond to the displayed information. For example, if the viewer wants to update the software of the receiver by pressing a predetermined key of a remote control, etc., for example, (Yes), the process proceeds to step S305. On the other hand, if the viewer does not want to update the software of the receiver by pressing another predetermined key of the remote control, etc., (No) the process proceeds to step S304.

At step S304, the system controller 105 outputs display information to the OSD display processing unit 106 for displaying the information and then the processing is terminated. In this case, the information provided from the information providing server and displayed is the same as the display information at step S207 previously described with reference to FIG. 2.

At step S305, the software of the digital broadcast receiver is updated and then the processing is terminated. The software update data of the digital broadcast receiver may be provided from the currently connected information providing server of the manufacturer of the receiver or in addition to the data displayed at step S304, step S302, the information of the server for providing the software update data of the receiver (URL, IP address, etc.,) may be provided from the information providing server, so that the receiver may be again connected to the server for providing the software update data to acquire the software update data of the receiver for updating the software of the receiver.

### Third Embodiment

In terrestrial digital broadcasts in Japan, it is imagined that in addition to broadcast for stationary receivers (12-segment broadcast), the same content will be broadcast (simulcast) as broadcast for portable reception terminals and mobile reception terminals (1-segment broadcast).

It is examined that scramble broadcast will not be executed, namely, revoke will not be executed in the 1-segment broadcast. In addition, if scramble broadcast is executed, the revoke execution criterion differs from that in the 12-segment broadcast; for example, it is also imagined that revoke will not be executed in the 1-segment broadcast although revoke will be executed in the 12-segment broadcast.

In a third embodiment of the invention, in such a case, a viewable broadcast is automatically selected and is provided for the viewer.

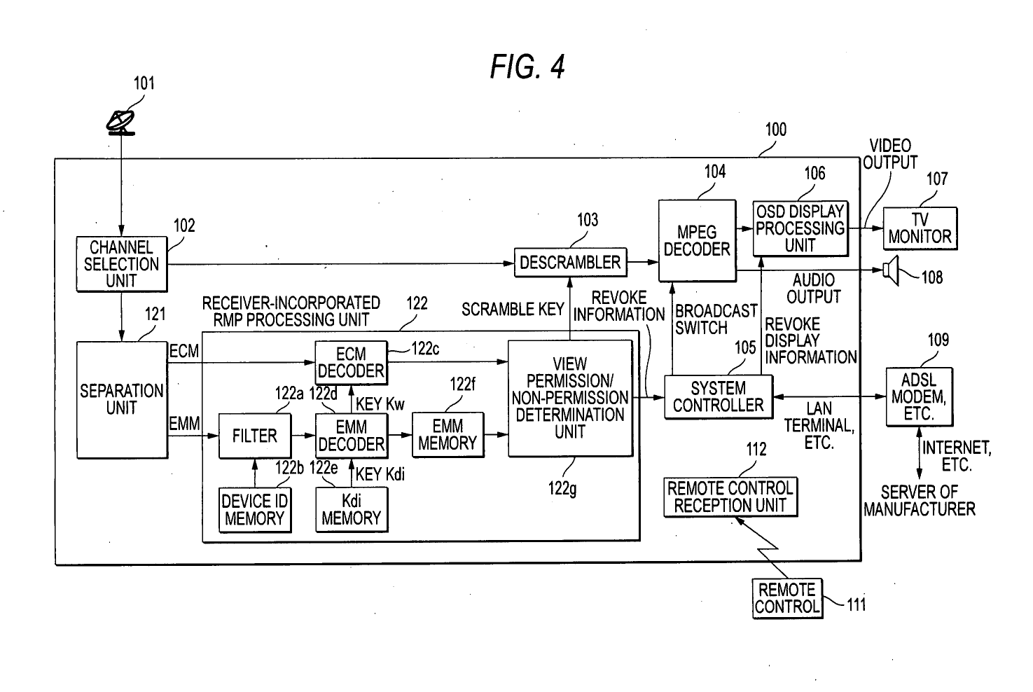

FIG. 4 is a block diagram to show the configuration of a digital broadcast receiver according to a third embodiment of the invention. The digital broadcast receiver in FIG. 4 differs from the digital broadcast receiver in FIG. 1 in that the system controller 105 receiving revoke information commands an MPEG decoder 104 to switch broadcasts.

The control operation of the system controller 105 if revoke is executed in 12-segment broadcast, for example, when the viewer views 12-segment broadcast will be discussed below in detail.

Upon reception of revoke information involved in the 12-segment broadcast, the system controller 105 determines whether or not revoke is executed in 1-segment broadcast depending on whether or not revoke information concerning the 1-segment broadcast exists. If the system controller 105 determines that revoke is not executed in the 1-segment broadcast, the system controller 105 commands the MPEG decoder 104 to switch from the 12-segment broadcast to the 1-segment broadcast. Consequently, if the 12-segment broadcast is simulcast with the 1-segment broadcast, the viewer can continue to view the 1-segment broadcast program although the image quality is degraded.

At this time, the system controller 105 controls an OSD display processing unit 106 to inform the viewer that the 12-segment broadcast is switched to the 1-segment broadcast because of revoke.

Further, in the display for informing the viewer, preferably, more detailed information concerning the revoke is also displayed as shown in FIGS. 1 and 2.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiments described above. For example, some components may be deleted from all components shown in the embodiment. Further, the components in different embodiments may be used appropriately in combination.

What is claimed is:

1. A method for receiving a digital broadcast signal by a digital broadcast receiver, the method comprising:
selecting a channel of any desired program out of the digital broadcast signal in which an ECM (Entitlement Control Message) and an EMM (Entitlement Management Message) are multiplexed and revoke information indicating whether or not the digital broadcast receiver is revoked is inserted into the EMM;
separating the ECM and the EMM from the digital broadcast signal of the selected channel;
decoding the separated ECM;
decoding the separated EMM;
descrambling the digital broadcast signal using a scramble key obtained from the decoded ECM;
determining whether or not viewing the desired program is permitted using the decoded ECM and the decoded EMM;
determining whether or not the digital broadcast receiver is revoked based on the decoded EMM;
connecting to a server that provides revoke relevant information and acquires the revoke relevant information when determined that the digital broadcast receiver is revoked; and
outputting the acquired revoke relevant information.

2. A method for receiving a digital broadcast signal by a digital broadcast receiver, the method comprising:
selecting a channel of any desired program out of the digital broadcast signal in which an ECM (Entitlement Control Message) and an EMM (Entitlement Management Message) are multiplexed and revoke information indicating whether or not the digital broadcast receiver is revoked is inserted into the EMM;
separating the ECM and the EMM from the digital broadcast signal of the selected channel;
decoding the separated ECM;
decoding the separated EMM;
descrambling the digital broadcast signal using a scramble key obtained from the decoded ECM;
determining whether or not viewing the desired program is permitted using the decoded ECM and the decoded EMM;
determining whether or not the digital broadcast receiver is revoked based on the decoded EMM;
connecting to a server that provides software update data and acquiring the software update data when determined that the digital broadcast receiver is revoked; and
updating software installed in the digital broadcast receiver using the acquired software update data.

3. A method for receiving a digital broadcast signal by a digital broadcast receiver, the method comprising:
selecting a channel of any desired program out of the digital broadcast signal in which an ECM (Entitlement Control Message) and an EMM (Entitlement Management Message) are multiplexed and revoke information indicating whether or not the digital broadcast receiver is revoked is inserted into the EMM;
separating the ECM and the EMM from the digital broadcast signal of the selected channel;
decoding the separated ECM;
decoding the separated EMM;
descrambling the digital broadcast signal using a scramble key obtained from the decoded ECM;
determining whether or not viewing the desired program is permitted using the decoded ECM and the decoded EMM;
determining whether or not the digital broadcast receiver is revoked based on the decoded EMM;
switching a reception system of the digital broadcast receiver between a broadcast system for stationary receivers and a broadcast system for mobile receivers, from one of the broadcast systems to the other when determined that the digital broadcast receiver is revoked in the one of the broadcast systems.
